(19) United States
(12) Patent Application Publication
(10) Pub. No.: US 2005/0046746 A1
(43) Pub. Date: Mar. 3, 2005

(54) Picture-in-picture apparatus

(76) Inventor: Young-hun Choi, Yongin-si (KR)

Correspondence Address: STANZIONE & KIM, LLP, 1740 N STREET, N.W., FIRST FLOOR, WASHINGTON, DC, 20036, US

(21) Appl. No.: 10/867,746

(22) Filed: Jun. 16, 2004

(30) Foreign Application Priority Data
Aug. 26, 2003 (KR) 2003-59098

(51) Int. Cl. H04N 5/45

(52) U.S. Cl. 348/565; 348/568

(57) ABSTRACT

A picture-in-picture apparatus which generates a picture-in-picture signal to display images using a small sub screen included in a main screen. The picture-in-picture apparatus includes a first deinterleaver which improves the definition of an image signal provided for the main screen, a second deinterleaver which improves the definition of an image signal provided for the sub screen, a first buffer which buffers the output of the first deinterleaver, a second buffer which buffers the output of the second deinterleaver, a downsampler which downsamples the output of the second buffer and generates an image signal corresponding to the sub screen, and a third buffer which synthesizes the outputs of the first buffer and the downsampler and generates the picture-in-picture signal.

### CROSS-REFERENCE TO RELATED APPLICATIONS

This application claims the priority of Korean Patent Application No. 2003-59098, filed on Aug. 26, 2003, in the Korean Intellectual Property Office, the disclosure of which is incorporated herein in its entirety.

### BACKGROUND OF THE INVENTION

1. Field of the Invention

The present general inventive concept relates to a picture-in-picture (PIP) apparatus, and more particularly, to a PIP apparatus that enhances the definition of a sub screen included in a main screen.

2. Description of the Related Art

In a PIP apparatus, a sub screen displays images simultaneously with a main screen displaying images such that the sub screen and the main screen display images from the same or different channels. When the main screen displays an image that has been reproduced from a video cassette recorder (VCR), a sub screen can display an image that has been reproduced from a television channel. Also, a user can change a position of a sub screen within a main screen. Such a PIP apparatus is disclosed in Korean Laid-open Patent Publications No. 1991-17864 and No. 1998-54366.

A synchronous frequency of a high-definition (HD) image signal is higher than that of a standard definition (SD) image signal, such as a national television system committee (NTSC) signal or a phase alternating line (PAL) signal. Accordingly, to improve the definition of an image signal, a deinterleaver that converts a scan rate of an SD image signal is used.

In a conventional display, the deinterleaver is located near the rear end of a PIP processing unit, and thus, the definition of a sub screen is very low compared with that of a main screen.

Specifically, to perform PIP processing, an image signal that is provided for a sub screen is downsampled and then synthesized with an image signal that is provided for a main screen. As a result of downsampling, the image signal of the sub screen, which is input to the deinterleaver, has less definition than the image signal of the main screen. In this case, even the deinterleaver cannot improve the definition of the sub screen to the definition of the main screen. Therefore, the definition of the sub screen is very low compared with the main screen.

Referring to FIG. 1, a conventional PIP apparatus comprises a downsampler 102, a first buffer 104, a second buffer 106, a third buffer 108, and a deinterleaver 110. The downsampler 102 downsamples an image signal of a sub screen. The first buffer 104 buffers an image signal of a main screen, and a second buffer 106 buffers the image signal of the sub screen, which is output from the downsampler 102. The third buffer 108 synthesizes the image signals of the main screen and the sub screen, which are output from the first buffer 104 and the second buffer 106, respectively, and generates a PIP image signal. The deinterleaver 110 deinterleaves the PIP image signal output from the third buffer 108 to improve the definition of the PIP image signal. The deinterleaver 110 converts an image signal with an interlaced scanning structure into an image signal with a progressive scanning structure. The image signal with the progressive scanning structure has a scan rate that is twice the scan rate of the image signal with the interlaced scanning structure. Here, a PIP image signal refers to an image signal corresponding to a screen comprised of a main screen and a sub screen.

A first A/V switch 112 and a second A/V switch 114 select image signals of the main screen and the sub screen, respectively, and a COMB filter 116 removes noise from the image signal of the main screen that is selected by the first A/V switch 112. The COMB filter 116 removes noise caused by cross-talk using a correlation between adjacent scan signals.

First and second video decoders 118 and 120 decode image signals of the main screen and the sub screen, respectively, and output image signals comprising luminance/chrominance signals Y/U/V.

A scaler 122 scales the output of the third buffer 108 such that the output of the third buffer 108 corresponds to a screen size of a display.

In the conventional PIP apparatus shown in FIG. 1, the image signal of the sub screen is downsampled by the downsampler 102, i.e., scaled down horizontally and vertically, and input to the second buffer 104. For example, supposing that the first A/V switch 112 and the second A/V switch 114 output image signals of 480i, if the sub screen is ½ or ¼ the size of the main screen, an image signal of 240i is input to the third buffer 108, if the sub screen is 1/9 the size of the main screen, an image signal of 160i is input to the third buffer 108, and if the sub screen is 1/16 the size of the main screen, an image signal of 120i is input to the third buffer 108. Here, i refers to interlaced scanning.

Accordingly, even if the PIP image signal of 480i is output from the third buffer 108, when it is deinterleaved by the deinterleaver 110 and converted into a PIP image signal of 480p (p refers to progressive scanning) to improve the scan rate, the definition of the sub screen is much less than that of the main screen.

### SUMMARY OF THE INVENTION

The present general inventive concept provides a PIP apparatus that enhances the definition of a sub screen included in a main screen.

The foregoing and/or other aspects of the present general inventive concept are achieved by providing a picture-in-picture apparatus which generates a picture-in-picture signal to display images using a sub screen included in a main screen. The picture-in-picture apparatus may include a first deinterleaver which improves the definition of the main screen by deinterleaving an image signal of the main screen; a second deinterleaver which improves the definition of the sub screen by deinterleaving an image signal of the sub screen; a first buffer which buffers the output of the first deinterleaver; a second buffer, which buffers the output of the second deinterleaver; a downsampler which downsamples the image signal of the sub screen output from the second buffer; and a third buffer which synthesizes the outputs of the first buffer and the downsampler and generates the picture-in-picture signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a conventional PIP apparatus;

FIG. 2 is a block diagram of a PIP apparatus according to an embodiment of the present general inventive concept; and

FIG. 3 is a block diagram of a portion of a PIP apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

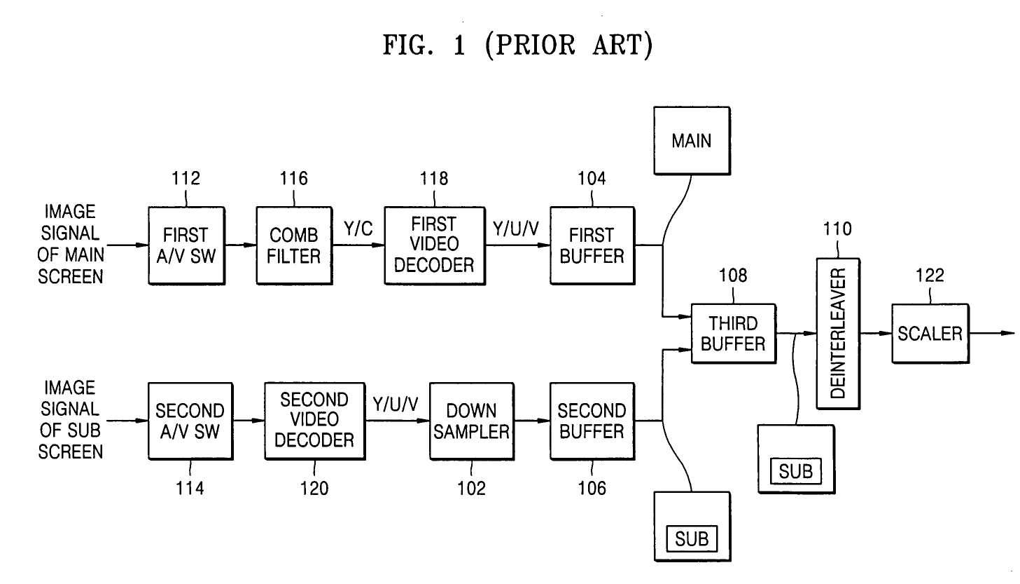

In contrast with the conventional PIP apparatus, such as the one illustrated in FIG. 1, in a PIP apparatus according to the the embodiments of the present general inventive concept, PIP processing can be performed after the definitions of a main screen and a sub screen are improved. Thus, the definition of the sub screen can be reliably enhanced. Specifically, deinterleavers that convert image signals of a main screen and a sub screen can be installed at the front end of a downsampler, thus improving the definition of the sub screen.

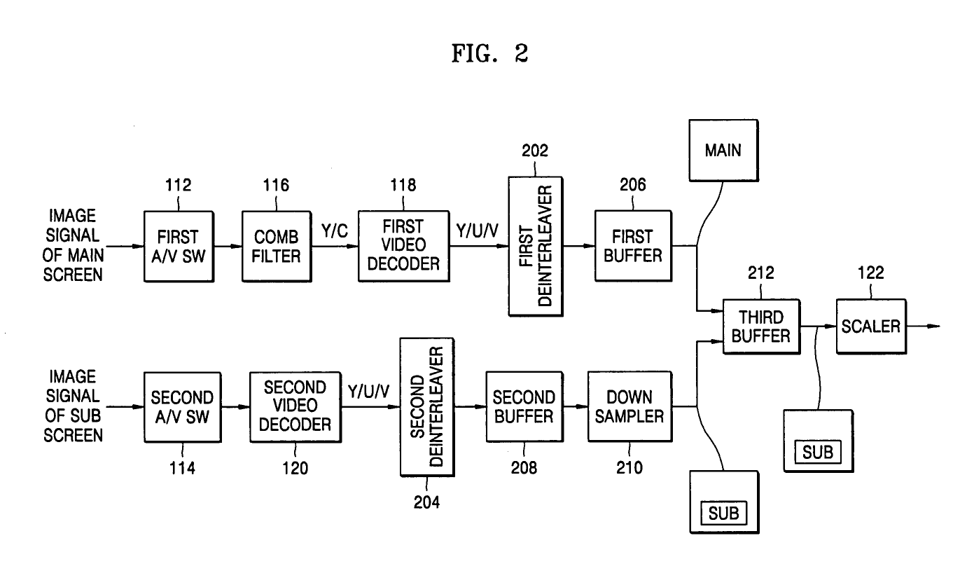

FIG. 2 is a block diagram of a PIP apparatus according to an embodiment of general inventive concept. The same reference numerals used in FIG. 1 are used to denote the same elements in FIG. 2 for purposes of being brief and concise, and a description thereof will not be repeated here.

Referring to FIG. 2, the PIP apparatus according to this embodiment may include first and second deinterleavers 202 and 204, first and second buffers 206 and 208, a downsampler 210, and a third buffer 212. The first and second deinterleavers 202 and 204 deinterleave image signals of a main screen and a sub screen, respectively, and improve the definitions of the main screen and the sub screen. The first and second buffers 206 and 208 buffer the outputs of the first and second deinterleavers 202 and 204, respectively. The downsampler 210 downsamples the deinterleaved image signal of the sub screen that is stored in the second buffer 208. The third buffer 212 synthesizes the outputs of the first buffer 206 and the downsampler 210 and generates a PIP image signal.

In the PIP apparatus of FIG. 2, the image signal of the sub screen is deinterleaved, downsampled, and synthesized with the image signal of the main screen. For example, supposing that a first A/V switch 112 and a second A/V switch 114 output image signals of 480i, as a result of the deinterleaving, if the sub screen is a ½ or ¼ the size of the main screen, an image signal of 240p is input to the third buffer 212, if the sub screen is a 1/9 the size of the main screen, an image signal of 160p is input to the third buffer 212, and if the sub screen is a 1/16 the size of the main screen, an image signal of 120p is input to the third buffer 212.

Thus, the definition of the sub screen is improved over that of the conventional PIP apparatus of FIG. 1.

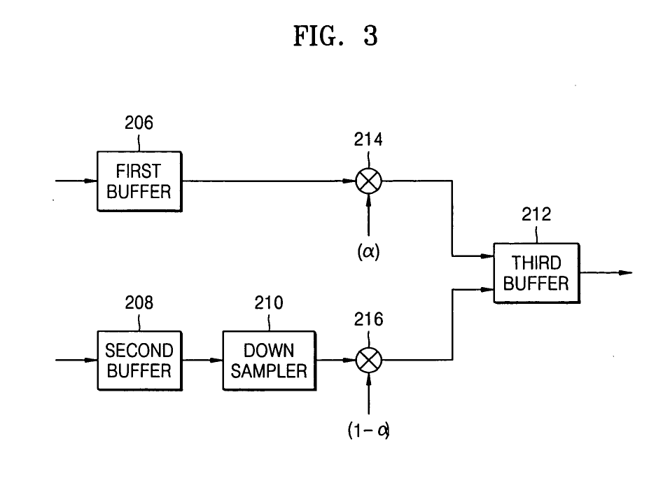

FIG. 3 is a block diagram of a portion of a PIP apparatus according to another embodiment of the present general inventive concept. Referring to FIG. 3, the PIP apparatus in this embodiment, in addition to the features illustrated in the embodiment of FIG. 2, may further include a first multiplier 214 that can multiply the output of the first buffer 206 by a and a second multiplier 216 that can multiply the output of the downsampler 210 by (1−a). Here, a is a real number between 0 and 1.

As described above, the PIP apparatuses of the various embodiments improve the definition of a sub screen, downsamples an image signal of the sub screen, and synthesizes the image signal of the sub screen with an image signal of a main screen. Thus, the definition of the sub screen can be enhanced.

Although a few embodiments of the present general inventive concept have been shown and described, it will be appreciated by those skilled in the art that changes may be made in these embodiments without departing from the principles and spirit of the invention, the scope of which is defined in the appended claims and their equivalents.

1. A picture-in-picture apparatus which generates a picture-in-picture signal to display images using a sub screen included in a main screen, the picture-in-picture apparatus comprising:
a first deinterleaver which improves the definition of the main screen by deinterleaving an image signal of the main screen;
a second deinterleaver which improves the definition of the sub screen by deinterleaving an image signal of the sub screen;
a first buffer which buffers the output of the first deinterleaver;
a second buffer, which buffers the output of the second deinterleaver;
a downsampler which downsamples the image signal of the sub screen output from the second buffer; and
a third buffer, which synthesizes the outputs of the first buffer and the downsampler and generates the picture-in-picture signal.

2. The picture-in-picture apparatus of claim 1, further comprising:
a first multiplier which multiplies the output of the first buffer by a first coefficient and transmits the result to the third buffer; and
a second multiplier, which multiplies the output of the downsampler by a second coefficient and transmits the result to the third buffer.

3. The picture-in-picture apparatus of claim 2, wherein the first coefficient is a, and the second coefficient is (1−a),
wherein a is a real number and 0≦a≦1.

4. A picture-in-picture apparatus which generates a picture-in-picture signal to display images using a sub screen included in a main screen, the picture-in-picture apparatus comprising:
a first deinterleaver to deinterleave an image signal of the main screen;
a second deinterleaver to deinterleave an image signal of the sub screen;
a downsampler to downsample the image signal of the sub screen output from the second deinterleaver; and
a buffer which synthesizes the outputs of the first deinterleaver and the downsampler and generates the picture-in-picture signal.

5. The picture-in-picture apparatus of claim 4, further comprising:
a first multiplier to multiply the output of the first deinterleaver by a first coefficient and transmit the result to the buffer; and
a second multiplier to multiply the output of the downsampler by a second coefficient and transmit the result to the buffer.

6. A method of generating a picture-in-picture signal to display images using a sub-screen included in a main screen, the method comprising:
deinterleaving an image signal of the main screen to generate the first deinterleaved image signal;
deinterleaving an image signal of the sub-screen to generate the second deinterleaved image signal;
buffering the first and second deinterleaved signals;
downsampling the buffered second deinterleaved image signal to generate a downsampled image signal; and
synthesizing the buffered first deinterleaved signal and the downsampled image signal to generate the picture-in-picture signal.

7. The method of claim 6, wherein the synthesizing operation is performed by a buffering operation.

8. A method of generating a picture-in-picture signal to display images using a sub-screen included in a main screen, the method comprising:
deinterleaving an image signal of the main screen;
deinterleaving an image signal of the sub-screen;
downsampling the deinterleaved image signal of the sub screen; and
synthesizing the deinterleaved image signal of the main screen and the deinterleaved and downsampled image signal of the sub-screen to generate the picture-in-picture signal.

9. A method of generating a picture-in-picture signal to display images using a sub-screen included in a main screen, the method comprising:
deinterleaving an image signal of the main screen and an image signal of the sub-screen; and
synthesizing the deinterleaved image signal of the main screen and the deinterleaved image signal of the sub-screen to generate the picture-in-picture signal.

10. The method of claim 9, wherein the synthesizing operation comprises buffering the progressive scanned image signal of the main screen and the progressive scanned image signal of the sub-screen simultaneously to generate a picture-in-picture signal.
